(19) United States
(12) Patent Application Publication
(10) Pub. No.: US 2017/0287005 A1
(43) Pub. Date: Oct. 5, 2017

(54) METHOD AND SYSTEM FOR MANAGING AUTHORITY TO CONTROL DIGITAL SIGNAGE, AND NON-TRANSITORY COMPUTER-REDABLE RECORDING MEDIUM THEREFOR

(71) Applicant: KNOWCK CO., LTD., Seoul (KR)

(72) Inventor: Jeung Ho KIM, Seoul (KR)

(73) Assignee: KNOWCK CO., LTD., Seoul (KR)

(21) Appl. No.: 15/315,213

(22) PCT Filed: Oct. 30, 2015
(86) PCT No.: PCT/KR2015/011556

§ 371 Date: Nov. 30, 2016

(51) Int. Cl. G06Q 30/02; G06F 3/147; H04W 4/02

(52) U.S. Cl. CPC G06Q 30/0261; G06Q 30/0271; H04W 4/025; G06F 3/147

(57) ABSTRACT

A method of managing a control authority over a digital signage includes, if a search request for a digital signage is received from a first user device, providing, to the first user device, information upon at least one digital signage over which the first user device is capable of making a request to have a control authority; and if a request for a control authority over a first digital signage is received from the first user device, determining the control authority over the first digital signage to be assigned to the first user device with reference to context information regarding at least one of the first user device, a user account related to the first user device and the first digital signage.

### TECHNICAL FIELD

The various embodiments described herein pertain generally to a method and system for managing an authority to control a digital signage, and, also relates to a non-transitory computer-readable recording medium therefor.

### BACKGROUND

Recently, the form of media which provide contents is diversified and the way to provide the contents is automated. In an outdoor advertisement, for example, a modern method of providing advertisement contents through a flexible medium such as a LED display or a LCD TV is introduced, beyond a typical method of providing advertisement contents through a stationary printed medium such as papers or films.

A so-called digital signage is a communication tool which an advertiser uses for marketing, advertisement, training, and so forth and through which a customer experience can be induced. Specifically, a digital signage refers to a digital imaging device configured to provide advertisement contents intended by the advertiser as well as typical broadcasting contents in a public place such as an airport, a hotel, a hospital, and so forth. The digital signage is also called a DID (Digital Information Display). Since the digital signage is equipped with a processor and a memory therein and is capable of displaying various types of contents vividly while being portable as well, it has a wide range of applications to marketing, customer services, information systems, etc., in public places such as department stores, subways, bus stops, and so forth. Further, not only the advertisement contents are provided through the digital signage, but various kinds of contents having various other purposes than the advertisement are also provided through the digital signage.

Recently, as the function of the digital signage is diversified and its utilization is wide-spread, there has been introduced a technology of supporting a user to control at least a partial function of the digital signage by using a typical user device such as his/her own smart phone, thus enabling interaction between the user and the digital signage. That is, the user is allowed to interact with the digital signage by using the user device, and is thus capable of gaining required information actively on his/her own or can be given a new user experience.

Since, however, the digital signage is generally installed in a place which may be exposed to many unspecified people, there arises a demand for a technology capable of managing a control authority over the digital signage between a multiple number of user devices.

### DISCLOSURE OF THE INVENTION

### Problems to be Solved by the Invention

Example embodiments of the present disclosure are conceived to meet the aforementioned requirements.

The example embodiments provide a technology of adaptively managing a control authority over a digital signage between a plurality of user devices by, if a search request for a digital signage is received from a first user device, providing, to the first user device, information upon at least one digital signage over which the first user device is capable of making a request to have a control authority; and if a request for a control authority over a first digital signage is received from the first user device, determining the control authority over the first digital signage to be assigned to the first user device with reference to context information regarding at least one of the first user device, a user account related to the first user device and the first digital signage.

### Means for Solving the Problems

Example embodiments of the present disclosure are as follows to meet the aforementioned requirements.

In one example embodiment, a method of managing a control authority over a digital signage includes, if a search request for a digital signage is received from a first user device, providing, to the first user device, information upon at least one digital signage over which the first user device is capable of making a request to have a control authority; and if a request for a control authority over a first digital signage is received from the first user device, determining the control authority over the first digital signage to be assigned to the first user device with reference to context information regarding at least one of the first user device, a user account related to the first user device and the first digital signage.

In another example embodiment, a system which manages a control authority over a digital signage includes an interfacing unit configured to, if a search request for a digital signage is received from a first user device, providing, to the first user device, information upon at least one digital signage over which the first user device is capable of making a request to have a control authority; and a control authority managing unit configured to, if a request for a control authority over a first digital signage is received from the first user device, determining the control authority over the first digital signage to be assigned to the first user device with reference to context information regarding at least one of the first user device, a user account related to the first user device and the first digital signage.

In still another example embodiment, a non-transitory computer-readable recording medium having stored thereon computer-executable instructions that, in response to execution, cause other method, other system and the method.

### Effect of the Invention

According to the example embodiments, a control authority over a digital signage can be adaptively managed between a plurality of user devices. Therefore, the user devices are allowed to interact with the digital signage without colliding or interfering with themselves.

### BRIEF DESCRIPTION OF THE DRAWINGS

FIG. 1 is a diagram illustrating a schematic configuration of an entire system for managing a control authority over a digital signage according to an example embodiment.

FIG. 2 is a diagram illustrating a detailed configuration of a management system 200 according to the example embodiment.

FIG. 3 is a diagram showing a mechanism by which a control authority over a digital signage is assigned to user devices.

### EXPLANATION OF REFERENCE NUMERALS

100: network

200: management system

210: interfacing unit

220: control authority managing unit

230: communication unit

240: control unit

300: user device

310 to 340: first to fourth user devices

400: digital signage

410 to 430: first to third digital signages

400A: digital signage group

### MODE FOR CARRYING OUT THE INVENTION

Hereinafter, example embodiments will be described in detail with reference to the accompanying drawings so that inventive concept may be readily implemented by those skilled in the art. The various example embodiments are different from each other but not intended to be mutually excluding. For example, specific shapes, structures and features described in the document may be modified without departing from the technical concept and scope of the present disclosure. Furthermore, positions or layout of individual parts within each example embodiment may also be changed or modified without departing from the technical concept and scope of the present disclosure. Thus, it is to be noted that the example embodiments to be describe below are not intended to be anyway limiting and various modifications may be made. The scope of the inventive concept is defined by the following claims and their equivalents rather than by the detailed description of the illustrative embodiments. It shall be understood that all modifications and embodiments conceived from the meaning and scope of the claims and their equivalents are included in the scope of the inventive concept. Through the drawings, like reference numerals represent like or similar parts in various aspects.

Hereinafter, the example embodiments will be discussed in detail with reference to the accompanying drawings so that the inventive concept may be easily implemented by a person having an ordinary skill in the art.

Configuration of Entire System

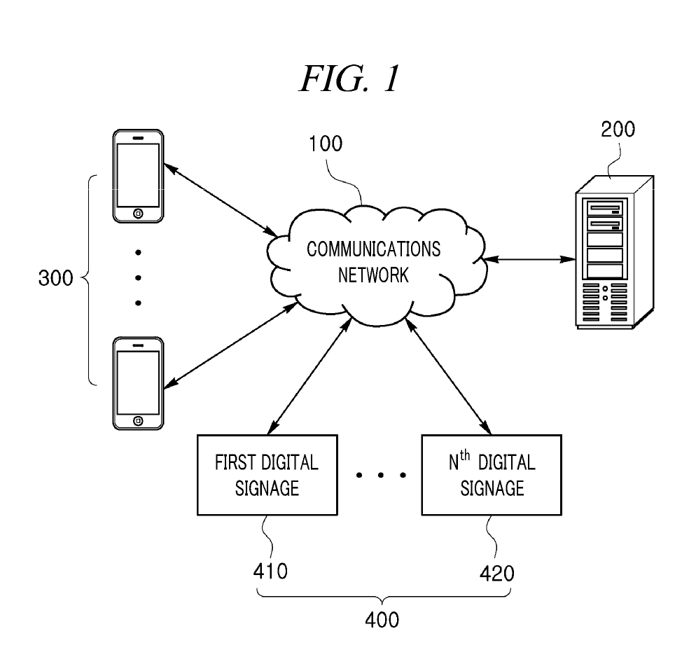

FIG. 1 is a diagram illustrating a schematic configuration of an entire system configured to manage a control authority over a digital signage according an example embodiment.

As depicted in FIG. 1, the entire system according to the exemplary embodiment includes a communications network 100, a management system 200, user devices 300 and a digital signage 400.

According to the example embodiment, the communication network 100 may be implemented by wired or wireless communications networks. Specifically, the communications network 100 may be implemented by any of various communications networks such as a LAN (Local Area Network), a MAN (Metropolitan Area Network), a WAN (Wide Area Network), and so forth. Desirably, the communications network 100 in this example embodiment may be implemented by well-known Internet or WWW (World Wide Web). However, the communications network 100 is not limited to the mentioned examples, and may include a commonly known wired or wireless data communications network, a commonly known telephone network, or a commonly known wired or wireless television broadcasting network as at least a part thereof. Particularly, according to the example embodiment, a wireless local area network such as WiFi, Bluetooth or RHO may be used as the communications network 100 capable of connecting the user devices 300 and the digital signage 400.

According to the example embodiment, the management system 200 is configured to perform a function of managing a control authority over the digital signage adaptively between a multiple number of user devices. Specifically, if a search request for the digital signage 400 is received from a user device 300, the management system 200 provides the user device 300 with information upon at least one digital signage 400 over which the user device 300 can make a request to have a control authority. If a request for a control authority over a first digital signage 410 is received from a first user device 310, the management system 200 determines a control authority over the first digital signage 410 to be assigned to the first user device 310 while referring to context information regarding the first user device 310, a user account related to the first user device 310 or the first digital signage 410.

The configuration and the operation of the management system 200 according to the example embodiment will be further elaborated later. Here, it should be noted that the above description of the management system 200 is nothing more than an example, and it is clearly understood by those skilled in the art that at least a part of functions or constituent components of the management system 200 may be embodied within the user device 300 or the digital signage 400, or included in the user device 300 or the digital signage 400 when necessary.

The user device 300 according to the example embodiment is a digital device having a function of allowing a user to access and communicate with the management system 200 or the digital signage 400. The use device 300 is not particularly limited as long as it is implemented by a digital device equipped with a memory and a microprocessor and thus has an operation ability. By way of non-limiting example, a smart phone, a tablet, a desktop computer, a laptop computer, a workstation, a PDA, a web pad, a mobile phone, or the like may be used as the user device 300.

Further, according to the example embodiment, the user device 300 is capable of performing a function of accessing the digital signage 400 over which it has a control authority and controlling at least a partial function of the digital signage 400, thus supporting the user to utilize the digital signage 400 actively. In the example embodiment, the digital device 300 may include an application (not shown) which performs the above-described function of the use device. This application may be downloaded from the management system 200 or a commonly known web server (not shown). Meanwhile, characteristics of such a program module may be substantially similar to those of an interfacing unit 210, a control authority managing unit 220, a communication unit 230 and a control unit 240 of the management system 200 to be described later. Here, at least a part of the application may be replaced by a hardware device or a firmware device capable of performing substantially the same or equivalent function as that of the application, when necessary.

According to the example embodiment, the digital signage 400 is capable of performing a function of providing an application or contents provided from the management system 200 to people around the digital signage 400. Further, according to the example embodiment, when performing at least a part of its function, the digital signage 400 is capable of interacting with the digital device 300 which is assigned the control authority over the digital signage 400.

To elaborate, according to the example embodiment, the digital signage 400 may further include a display such as a LCD panel or an OLED panel and an audio equipment such as a speaker for sound output.

Further, according to the example embodiment, the digital signage 400 may be installed in public places such as a department store, a subway, a bus stop, an air port, a hotel, a hospital, and so forth. However, it should be noted that these installation places are just examples, and the place where the digital signage 400 is installed is not limited to the aforementioned examples.

Meanwhile, a process in which a user uses the digital signage 400 according to the example embodiment will be schematically described later.

Configuration of Management System

Now, an internal configuration of the management system 200 and functions of individual components thereof will be explained according to the example embodiment.

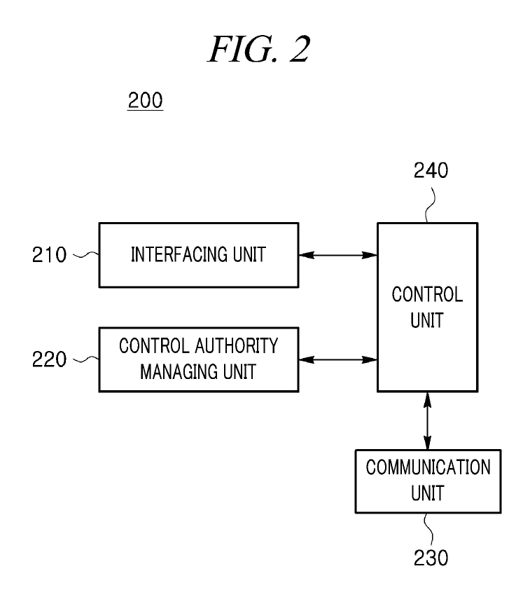

FIG. 2 is a diagram which provides a detailed view of the internal configuration of the management system 200 according to the example embodiment.

As illustrated in FIG. 2, the management system 200 according to the example embodiment includes the interfacing unit 210, the control authority managing unit 220, the communication unit 230 and the control unit 240. In the example embodiment, at least a part of the interfacing unit 210, the control authority managing unit 220, the communication unit 230 and the control unit 240 may be a program module which communicates with the user device 300 or the digital signage 400. This program module may be included in the management system 200 in the form of an operating system, an application program module or other program modules, and, physically, may be stored in various types of commonly known storage devices. Alternatively, this program module may be stored in a remote storage device which is capable of communicating with the management system 200. Meanwhile, this program module may include, but not limited to, a routine, a sub-routine, a program, an object, a component, a data structure for implementing a specific abstract data type or a specific operation to be described later.

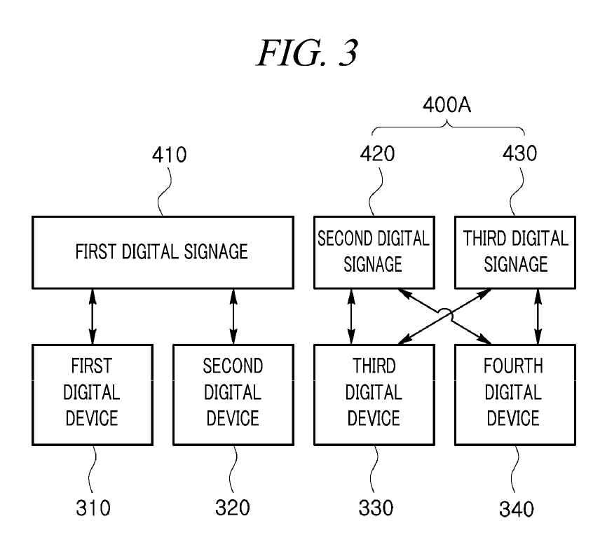

FIG. 3 is a diagram illustrating a mechanism by which control authorities over the digital signages 410 and 420 are assigned to the user devices 310, 320, 330 and 340 according to the exemplary embodiment. Below, this mechanism of assigning the control authorities over the digital signages 410 and 420 to the user devices 310, 320, 330 and 340 will be discussed with reference to FIG. 3.

According to the example embodiment, if a search request for the digital signage 400 is received from the first user device 310, the interfacing unit 210 searches for one or more digital signages 410 and 420 over which the first user device 310 can make a request to have a control authority (that is, which can be connected with the first user device 310). Then, the interfacing unit 210 provides the first device 310 with information upon the retrieved one or more digital signages 410 and 420.

Here, according to the example embodiment, the one or more digital signages over which the user device 300 can make the request to have the control authority may be the digital signages 410 and 420 which exist within a preset distance from the user device 310 and can be connected with the first user device 310 through the wired or wireless communications network 100.

Further, according to the example embodiment, the interfacing unit 210 is capable of performing a function receiving a request for a control authority over the first digital signage 410 (or the second digital signage 420) from the first user device 310. Here, the first digital signage 410 may be a digital signage selected by the first user device.

According to the example embodiment, if the request for demanding the control authority over the first digital signage 410 is received from the first user device 310, the control authority managing unit 220 determines a control authority over the first digital signage 410 to be assigned to the first user device 310 while referring to context information regarding at least one of the first user device 310, a user account related to the first user device 310 and the first digital signage 410.

Furthermore, according to the example embodiment, if a request for demanding a control authority over the first digital signage 410 is received from the second user device 320, the control authority managing unit 220 determines a control authority over the first digital signage 410 to be assigned to the second user device 320 while referring to context information regarding at least one of the second user device 320, a user account related to the second use device 320 and the first digital signage 410 as well as information upon the control authority over the first digital signage 410 already assigned to the first user device 310. Here, according to the exemplary embodiment, the control authority over the first digital signage 410 assigned to the first user device 310 and the control authority over the first digital signage 410 assigned to the second user device 320 may be determined not to collide with or be overlapped with each other.

Moreover, according to the example embodiment, if a control authority over a certain digital signage is assigned to a certain digital device, the control authority managing unit 220 may also assign this digital device a control authority over another digital signage which belongs to the same group as the certain digital group. By way of example, the third user device 330 assigned a control authority over the second digital signage 420 may also be assigned a control authority over a third digital signage 430 belonging to the same group 400A as the second digital signage 420.

Here, according to the example embodiment, the control authority over the first digital signage 410 to be assigned to the first user device 310 may specify a time during which the first user device 310 is capable of controlling the first digital signage 410, a scope of applications controllable by the first user device 310 among the applications executed in the first digital signage 410, a scope of contents controllable by the first user device 310 among the contents provided by the first digital signage 410, a scope of another digital signage 420 controllable by the first user device 310 among the another digital signages 420 connected to the first digital signage 410, and the like.

To elaborate, according to the example embodiment, the context information regarding the first user device 310 which can be a reference in determining the control authority may include information upon, for example, specifications, performance and location of the first user device. By way of example, the control authority managing unit 220 according to the example embodiment may assign the first user device 310 an authority for controlling a keyboard input function of the digital signage 410 by referring to context information that the first user device 310 which has made a request for the control authority over the first digital signage 410 is equipped with a keyboard input device.

Furthermore, according to the example embodiment, the context information regarding the user account related to the first user device 310 which can be a reference in determining the control authority may include information upon an authority possessed by the user account, demographic information of the user, etc. For example, the control authority managing unit 220 according to the example embodiment may assign the first user device 310 an authority allowing the first user device 310 to access, among the contents provided by the first digital signage 410, contents except those for adults only.

In addition, according to the example embodiment, the context information upon the first digital signage 410 that can be a reference in determining the control authority may include the number of other user devices 320, 330 and 340 which are given control authorities over the first digital signage 410, the number of other user devices 320, 330 and 340 capable of making a request to possess a control authority over the first digital signage 410, the number of other user devices 320, 330, 340 which exist within a preset distance from the first digital signage 410, and so forth. For example, with the rise of the number of the other user devices 320, 330 and 340 having the control authority over the first digital signage 410, the control authority managing unit 220 may shorten the time during which the first user device 310 is capable of controlling the first digital signage 410.

Moreover, according to the example embodiment, the control authority managing unit 220 may modify control authorities over the digital signages 410 to 430 assigned to the user devices 310 to 340 dynamically as the context information changes. For example, in case that previously assigned control authorities need to be adjusted because the number of user devices which have made a request for a control authority over the first digital signage 410 exceeds a preset number, the authority control managing unit 220 may deprive at least one user device (for instance, a user device which has possessed a control authority over the first digital signage 410 for the longest duration) of the control authority over the first digital signage 410.

Meanwhile, according to the example embodiment, if the control authority over the first digital signage is given to the first user device 310, the control authority managing unit 220 may allow control commands received from the user device 310 to be transmitted to the first digital signage 410 by being encoded according to a predetermined algorithm. By way of example, data transceived between the first user device and the first digital signage may be encoded according to a RSA encoding algorithm, so that the digital signage 400 is prevented from being controlled by an unauthorized user device (not shown). Thus, leakage of private information of the user through the digital signage 400 which can be shared by the plurality of user devices 300 can be avoided.

According to the example embodiment, the communication unit 230 is configured to perform a function of enabling transmission/reception of data from/to the management system 200.

The control unit 240 according to the example embodiment may perform a function of controlling a data flow between the interfacing unit 210, the control authority managing unit 220 and the communication unit 230. That is, the control unit 240 according to the example embodiment is capable of controlling the interfacing unit 210, the control authority managing unit 220 and the communication unit 230 to perform their own functions by controlling a data flow from/to the outside of the management system 200 and a data flow between the individual components of the management system 200.

So far, the example embodiment has been described for the case where the target of control which is controllable by the user device is a digital signage. However, the present disclosure is not limited to the above-described example embodiment. For example, according to another example embodiment, any of various devices can be a target of control method of the present disclosure as long s the devices are equipped with a memory and a microprocessor and thus has an operation ability. By way of non-limiting example, a smart phone, a tablet, a desktop computer, a laptop computer, a workstation, a wearable device, other IoT (Internet of Things) devices (including watches, cars, and household appliances such as refrigerators, washing machines, boilers, air conditions, etc.). A management system 200 according to another example embodiment may be configured to assign a control authority over the various devices as mentioned above to at least one user device.

The above-described example embodiments may be embodied in the form of program instruction codes that can be executed by various computer components and stored in a computer-readable recording medium. The computer-readable recording medium may include program instruction codes, data files and data structures alone or in combinations. The program instruction codes recorded in the computer-readable recording medium may be designed and composed for the purse of present disclosure or may be commonly known and available to those skilled in the field of computer software. Examples of the computer-readable recording medium include a magnetic medium such as a hard disk, a floppy disk or a magnetic tape, an optical medium such as a CD-ROM or a DVD, a magneto-optical medium such as a floptical disk, and a hardware device, such as a ROM, a RAM or a flash memory, which is specially designed to store and execute program instruction codes. Examples of the program instruction codes include high-level language codes capable of being executed by using an interpreter or the like as well as machine language codes created by a compiler, for example. The hardware device may be changed to at least one software module to perform the process of the example embodiments, and vice versa.

The above description of the example embodiments is provided for the purpose of illustration, and it would be understood by those skilled in the art that various changes and modifications may be made without changing technical conception and essential features of the example embodiments.

Thus, it is clear that the above-described example embodiments are illustrative in all aspects and do not limit the present disclosure. The scope of the inventive concept is defined by the following claims and their equivalents rather than by the detailed description of the illustrative embodiments. It shall be understood that all modifications and embodiments conceived from the meaning and scope of the claims and their equivalents are included in the scope of the inventive concept.

1. A method of managing a control authority over a digital signage, comprising:
if a search request for a digital signage is received from a first user device, providing, to the first user device, information upon at least one digital signage over which the first user device is capable of making a request to have a control authority; and
if a request for a control authority over a first digital signage is received from the first user device, determining the control authority over the first digital signage to be assigned to the first user device with reference to context information regarding at least one of the first user device, a user account related to the first user device and the first digital signage.

2. The method of claim 1,
wherein the control authority is configured to specify at least one of a time during which the first user device is capable of controlling the first digital signage, a scope of applications controllable by the first user device among applications executed in the first digital signage, a scope of contents controllable by the first user device among contents provided by the first digital signage, and a scope of other digital signages controllable by the first user device among other digital signages connected to the first digital signage.

3. The method of claim 1,
wherein the at least one digital signage over which the first user device is capable of making the request to have the control authority includes a digital signage which exists within a preset distance from the first user device.

4. The method of claim 1,
wherein the context information regarding the first user device includes information upon at least one of specifications, performance and location of the first user device.

5. The method of claim 1,
wherein the context information regarding the user account related to the first user device includes information upon at least one of an authority possessed by the user account and demographic information of a user.

6. The method of claim 1,
wherein the context information regarding the first digital signage includes information upon at least one of the number of other user devices which are given control authorities over the first digital signage, the number of other user devices capable of making a request to possess a control authority over the first digital signage, the number of other user devices which exist within a preset distance from the first digital signage.

7. The method of claim 1,
wherein the control authority is dynamically modified as the context information is changed.

8. The method of claim 1, further comprising:
if the control authority over the first digital signage is assigned to the first user device, assigning the first user device a control authority over another digital signage belonging to a same group as the first digital signage.

9. The method of claim 1, further comprising:
if a request for a control authority over the first digital signage is received from a second user device, determining the control authority over the first digital signage to be assigned to the second user device with reference to context information regarding at least one of the second user device, a user account related to the second user device and the first digital signage as well as information upon the control authority over the first digital signage pre-assigned to the first user device.

10. The method of claim 1, further comprising:
if the control authority over the first digital signage is assigned to the first user device, encoding data to be transceived between the first user device and the first digital signage according to a preset algorithm.

11. A non-transitory computer-readable recording medium having
stored thereon computer-executable instructions that, in response to execution, cause the method as claimed in claim 1 to be performed.

12. A system which manages a control authority over a digital signage, comprising:
an interfacing unit configured to, if a search request for a digital signage is received from a first user device, providing, to the first user device, information upon at least one digital signage over which the first user device is capable of making a request to have a control authority; and
a control authority managing unit configured to, if a request for a control authority over a first digital signage is received from the first user device, determining the control authority over the first digital signage to be assigned to the first user device with reference to context information regarding at least one of the first user device, a user account related to the first user device and the first digital signage.
